(19) United States
(12) Patent Application Publication
(10) Pub. No.: US 2014/0011906 A1
(43) Pub. Date: Jan. 9, 2014

(54) SURFACE TREATMENT INCLUDING A HEAT LABILE COMPONENT/CARRIER COMBINATION

(71) Applicants: Frank M. Fosco, JR., Plainfield, IL (US); Edward E. Sowers, Plainfield, IN (US)

(72) Inventors: Frank M. Fosco, JR., Plainfield, IL (US); Edward E. Sowers, Plainfield, IN (US)

(21) Appl. No.: 13/728,449

(22) Filed: Dec. 27, 2012

Related U.S. Application Data
(63) Continuation-in-part of application No. 13/724,500, filed on Dec. 21, 2012.
Application No. 13/724,500 is a continuation-in-part of application No. 13/550,165, filed on Jul. 16, 2012.
(60) Provisional application No. 61/508,354, filed on Jul. 15, 2011.
(60) Provisional application No. 61/537,270, filed on Sep. 21, 2011.
(60) Provisional application No. 61/537,272, filed on Sep. 21, 2011.
(60) Provisional application No. 61/580,429, filed on Dec. 27, 2011.
(60) Provisional application No. 61/581,225, filed on Dec. 29, 2011.
(60) Provisional application No. 61/580,858, filed on Dec. 28, 2011.
(60) Provisional application No. 61/580,842, filed on Dec. 28, 2011.
(60) Provisional application No. 61/580,767, filed on Dec. 28, 2011.
(60) Provisional application No. 61/580,440, filed on Dec. 27, 2011.
(60) Provisional application No. 61/580,431, filed on Dec. 27, 2011.

(51) Int. Cl. C09D 5/14; B05D 7/24

(52) U.S. Cl. CPC C09D 5/14; B05D 7/24
USPC 523/122; 427/398.1

(57) ABSTRACT

Provided herein are surface treatments such as paints, coatings, stains, varnishes, sealants, films, inks, and the like, containing heat labile component/carrier combinations and methods for making the formulations suitable for treating surfaces. The surface treatments and/or the treated surfaces can be subjected to elevated temperatures at or above which the heat labile component alone decomposes, reacts, or volatilizes. Because the heat labile component adsorbed on the carrier survives the elevated temperature, the resulting treated surfaces exhibit properties derived from the heat labile component(s). Resulting treated surfaces can exhibit properties derived from one or a combination of heat labile components including, but not limited to bacteriocides, fungicides, algaecides, viruscides, insecticides, antibiotics, enzymes, repellents (animal and insect), herbicides, pheromones, molluscicides, acaricides, miticides, rodenticides, fragrances, and the like. Otherwise incompatible components can similarly be included in surface treatments using the carrier technology.

### CROSS-REFERENCE TO RELATED APPLICATIONS

This application is a continuation-in-part of U.S. patent application Ser. No. 13/724,500 filed on Dec. 21, 2012 which is a continuation in part of Ser. No. 13/550,165 filed on Jul. 16, 2012, which claims the benefit of U.S. Provisional Patent Application No. 61/508,354, filed Jul. 15, 2011, U.S. Provisional Application No. 61/537,270, filed Sep. 21, 2011, and U.S. Provisional Application No. 61/537,272, filed Sep. 21, 2011, and this Application also claims the benefit of U.S. Provisional Application No. 61/580,429, filed Dec. 27, 2011, U.S. Provisional Application No. 61/580,431, filed Dec. 27, 2011, U.S. Provisional Application No. 61/580,440, filed Dec. 27, 2011, U.S. Provisional Application No. 61/580,767, filed Dec. 28, 2011, U.S. Provisional Application No. 61/580,842, filed Dec. 28, 2011, U.S. Provisional Application No. 61/580,858, filed Dec. 28, 2011, and U.S. Provisional Application No. 61/581,225, filed Dec. 29, 2011, all of which are hereby incorporated by reference in their entirety.

### BACKGROUND

The terms paints, coatings, stains, varnishes, sealants, films, inks, and the like describe several types of formulations applied to surfaces to protect and/or provide aesthetic qualities to the surfaces. Inks can additionally provide images and/or information. The present disclosure relates to formulations in the form of paints, coatings, stains, varnishes, sealants, films, inks, and the like (collectively, “surface treatments”) which include a heat labile component added to impart a particular property to a surface to which a surface treatment is applied. The heat labile components include components which decompose and/or volatilize at temperatures greater than ambient temperatures. In the surface treatments disclosed, a heat labile component/carrier combination is utilized to prevent decomposition and/or volatilization of the heat labile component at elevated temperatures incurred during application or subsequent thereto. The use of a heat labile component/carrier combination is particularly useful in a surface treatment which experiences elevated exposure temperatures either during a processing, curing or drying stage or which experiences elevated service temperatures after application because of the treated surface's environment. Examples of elevated exposure temperatures include, but are not limited to drying temperatures, application temperatures, curing temperatures, and/or temperatures incurred during the surface treatment's service (collectively, “elevated exposure temperatures”).

The inclusion of a heat labile component/carrier combination into a surface treatment can provide important properties to a treated surface. For example, if the heat labile component is a biocide, such treated surfaces treated with a surface treatment containing a biocide/carrier combination can be more resistant to biological degradation and provide surfaces that don't support the growth of a range of organisms and/or viruses and which can kill targeted organisms (including bacteria, fungi, algae, viruses, and the like) which contact the surface. Surfaces can include porous and nonporous surfaces. Examples include, but are not limited to metal; wood; polymer; fabric, including woven and nonwoven fabrics; ceramic, glass, composite, masonry, stone; and other surfaces. Such surfaces find particular uses where a need exists to create surfaces on furniture, equipment, and fabrics capable of: resisting the colonization of microorganisms, killing microorganisms upon contact, and/or providing a barrier to microorganisms. Unlike topical applications of biocides which typically provide a concentration gradient across the applied surface leading to resistant strains, a surface treated with a surface treatment/biocide/carrier combination having a uniform distribution of the surface treatment including a biocide therein, lacks a concentration gradient and at proper levels minimizes the formation of resistant strains. In addition, performance of this treated surface is not dependent on whether a surface disinfectant was or was not applied according to established procedures. The ability to provide and maintain such substantially sterile coated surfaces and minimize the formation of resistant strains of microorganisms is particularly important in a host of applications involving surfaces we routinely touch and which contact the various fluids we come in contact with on a daily basis. The ability to maintain substantially sterile surfaces is particularly important in today's hospital, school, and home environments and in related fields. The use of a heat labile component/carrier combination allows a heat labile component to be incorporated into a surface treatment which is exposed to elevated temperatures at the application stage or subsequent to application.

Stability of the heat labile component can be important during the surface treatment processes and the use of the surface treated article/object. Many surface treatments used to coat or treat surfaces, articles, synthetic fabrics, and the like, are subjected to elevated temperatures to either cure the surface treatment, to modify the surface in some way, or to reduce the drying time. Depending on the surface treatment and the surface treated, such processing temperatures typically range from about 65° C. to about 500° C. For a surface treatment/biocide combination to be successfully applied utilizing standard methods, the biocide must have sufficient thermal stability to survive the elevated temperatures during the processing step. Currently only a limited number of biocides have been successfully incorporated into surface treatments which must be applied and maintained at substantially ambient temperatures. Subjecting these compositions to elevated temperatures has typically inactivated the biocide included in the surface treatment.

In addition, some surfaces experience elevated temperatures above the biocide's decomposition temperature (or the decomposition temperature of other heat labile compounds) for periods of time after application of the surface treatment. For example, a dark painted surface exposed to sunlight for extended periods of time can reach temperatures above the biocide's decomposition temperature (≧80° C.). Stove tops and interiors of microwave ovens similarly periodically reach elevated temperatures during their normal usage. What is needed is a range of surface treatment/heat labile component/carrier compositions which can be engineered in a variety of forms utilizing substantially standard manufacturing techniques and which can include one or more heat labile components selected to fulfill a specific need, without regard to whether or not the heat labile component alone has sufficient thermal stability to survive the necessary processing involved with application/curing/or drying or service. Further, methods are needed for producing surface treatments derived from such surface treatment/heat labile component/carrier compositions, wherein the heat labile compound's necessary properties are maintained following one or several exposures of the article/object to elevated temperatures. The current disclosure addresses these needs.

### SUMMARY

In its broadest form, the present disclosure provides for a surface treatment having an exposure temperature and including a heat labile component adsorbed on a carrier. The heat labile component has a decomposition temperature, and the surface treatment's exposure temperature is greater than or equal to the heat labile component's decomposition temperature. The surface treatment is capable of experiencing its exposure temperature without decomposition of the heat labile component. The exposure temperature can be a processing temperature the surface treatment experiences during the treatment's application or a service temperature, a temperature the treatment experiences following its application. In some applications a surface is typically treated with a surface treatment/heat labile component/carrier combination, and subjected to an elevated temperature. The elevated temperatures can occur in an effort to cure, dry, or otherwise modify the surface's properties or appearance or as a result of the environmental conditions the surface is exposed to. In these applications exposure of a heat labile component to the elevated temperatures without being adsorbed on a carrier would cause the heat labile component to decompose or volatilize. Failure of an un-adsorbed heat labile component to survive can result in inactivation, decomposition, reaction, volatilization and the like, depending on the component's heat labile nature.

Examples of surface treatments include, but are not limited to, paints, coatings, stains, varnishes, sealants, films, inks, and the like, further including a one or more components that render treated surface toxic to and relatively free from a range of disease and infection causing microorganisms. For surface treatments that are subjected to elevated temperatures and which require heat labile components, the heat labile component can be adsorbed onto a carrier particle and the heat labile component/carrier combination utilized in the surface treatment. Adsorption onto the carrier particle substantially increases the thermal stability of the heat labile component and allows the heat labile component to survive repeated exposures to elevated temperatures above decomposition and/or volatilization temperatures. The surface treatment compositions can be a solid, a liquid, or a combination thereof. Useful heat labile components include, but are not limited to, a wide range of biocides, repellents, UV stabilizers, fragrances, and the like, which suffer decomposition, volatilization, or a combination thereof, upon normal exposure to an elevated temperature. The compositions disclosed herein are typically exposed to elevated temperatures as part of an application process (processing temperatures) or subsequent to the surface treatment's application through the surfaces environment (service temperatures).

A suitable carrier is typically a porous material which is stable and remains solid at the processing temperature (including an elevated temperature) upon which a sufficient amount of a heat labile component can be adsorbed. Certain carriers can have a relatively low thermal conductivity to minimize the transfer of heat into the particle. Carriers can be porous inorganic or organic in nature. Based on current work, examples of inorganic carriers include porous silica particles whereas examples of organic carriers include porous organic polymers. Because some heat labile components are not compatible when directly mixed, the loading of a single heat labile component onto a single carrier frequently provides improved results, and the use of a multiple of heat labile components/carriers avoids this potential problem. The carrier particles can be any size that doesn't interfere with application of the surface treatment and subsequent use of the treated surface, or the surfaces aesthetic qualities. Carrier particles as small as 1 micron have been utilized to provide effective results. A more detailed discussion of carriers will follow in the next section.

A further aspect of the present disclosure also provides a method for preparing a treated surface with a surface treatment/heat labile component/carrier combination. One aspect of the method involves the steps of: (a) applying a composition including a surface treatment and a heat labile component adsorbed on a carrier to a surface to form a treated surface, wherein the surface treatment has a processing or exposure temperature and the heat labile component has a decomposition temperature; (b) subjecting the treated surface to a processing temperature for a time sufficient to cure, dry, or otherwise modify the surface treatment; and (c) cooling the treated surface to form a protected surface including the surface treatment containing the heat labile component adsorbed on the carrier, where: (i) the processing or exposure temperature is greater than the heat labile component's decomposition temperature; (ii) the heat labile component adsorbed on the carrier is distributed across the treated surface, and (iii) the heat labile component possesses properties, and the treated surface exhibits the properties derived from the heat labile component. The composition including a surface treatment and a heat labile component adsorbed on a carrier can be a solid, a liquid, or a combination thereof. A still further aspect of this disclosure involves surfaces treated with a surface treatment including a heat labile component/carrier combination that has passed through an elevated temperature either during application of the surface treatment or subsequent to application. The heat labile components involved possess a property that is exhibited by the treated surface containing the heat labile component/carrier combination following exposure to an elevated temperature.

A heat labile component includes a component that decomposes, reacts, or volatilizes when exposed to an elevated temperature changing or destroying its properties or removing the component from the treated surface. Suitable heat labile components can include materials having a wide range of properties. Examples of heat labile components include, but are not limited to bacteriocides, fungicides, algaecides, viruscides, insecticides, antibiotics, enzymes, repellents (animal and insect), herbicides, pheromones, molluscicides, acaricides, miticides, rodenticides, fragrances, and the like. Incorporation of these components in a surface treatment allows the properties associated with the component to be exhibited on or in the vicinity of the treated surface, even if during the processing of the surface or during its service, the treated surface is exposed to an elevated temperature sufficient to have caused decomposition or removal of the heat labile component without the carrier's presence.

A still further aspect of this present disclosure involves a method for preparing a surface treatment that includes the steps of providing a surface treatment; providing a heat labile component adsorbed on a carrier; and combining the heat labile component adsorbed on a carrier and the coating formulation. The surface treatment can be a coating formulation selected from the group consisting of paint, a coating, a stain, a varnish, a sealant, a film, and an ink. The heat labile component can be selected from the group consisting of a bactericides, fungicides, insecticides, rodenticides, volatile fragrances (including animal and insect repellants), and combinations thereof. In one example, the use of a volatile component/carrier combination in a printing ink of the type used in offset presses where heat is used to rapidly dry the ink is particularly useful, enabling certain pages or portions thereof to exhibit a particular fragrance or other property.

A still further aspect of the current disclosure involves a surface having a surface treatment including a heat labile component adsorbed on a carrier, where (a) the surface treatment has an exposure temperature; (b) the heat labile component has a decomposition temperature, and (c) the surface treatment's exposure temperature is ≧ to the heat labile component's decomposition temperature; and the surface treatment is capable of experiencing the exposure temperature without decomposition of the heat labile component. The surface treatment's exposure treatment can include a processing temperature or a service temperature.

The heat labile component can be adsorbed on the carrier by contacting the carrier with a liquid form of the heat labile component. If heat labile component is a liquid at a temperature below its decomposition temperature it can be used directly in its liquid form. If the heat labile component is a solid at the temperature necessary for placing on the carrier, it can be dispersed or dissolved in a solvent, prior to loading onto the carrier. Any remaining solvent or dispersant can be removed or evaporated to provide solid and flow-able carrier particles containing the heat labile component. If the solvent is compatible with the surface treatment formulation in the amount present, the solvent-wet loaded carrier particle can be used directly without drying. For a carrier to be loaded with a dispersion of the heat labile component, the component's particle size should be smaller than the carrier's pores being entered.

Surfaces suited for application of the surface treatments described herein and which require and/or experience an elevated temperature, include any surface which can be heated to facilitate curing, drying, or modification of the treated surface. As far as the surface is concerned, it must be capable of accepting the surface treatment, and any subsequent period of exposure to an elevated temperature. Examples of surfaces contemplated include, but are not limited to contiguous surfaces, mesh surfaces, porous surfaces, nonporous surfaces, woven surfaces, and the like. Examples of materials suitable for use as surfaces include, but are not limited to, metal, polymeric materials, natural materials such as cellulose, cotton and other natural fibers. The combination of a surface and a surface treatment containing a heat labile component/carrier combination generally results in a useful property being imparted to the treated surface by the surface treatment. The presence of the heat labile component/carrier combination within the surface treatment does not generally alter the surface treatment's appearance upon application, but the treated surface typically demonstrates new properties based on the heat labile components presence. Surfaces containing a heat labile component/carrier combination can remain sterile, kill microorganisms and the like upon contact, and prevent the spread of microorganisms though serial contact by other organisms. Surfaces containing a repellent, such as an animal and/or insect repellent, can maintain a region about the surface free of animals, insects and the like. A surface containing an insecticide can kill insects sensitive to the insecticide utilized that contact the treated surface. A surface containing a combination pheromone/insecticide can attract pheromone sensitive insects and upon contacting the surface kill insects sensitive to the insecticide utilized.

Surfaces utilizing surface treatments containing heat labile biocides are particularly useful for controlling microorganisms which are spread by direct serial contact or a combination of serial contact and exposure to aerosols from sneezing and coughing and direct contact. Surface treatments including one or more enzymes can effect chemical transformations upon contact, thus decomposing pesticides, nerve gases, and the like. Finally, surface treatments can be designed to exhibit a single property or a plurality of properties. Surfaces which will benefit from the protection described herein include porous and nonporous surfaces. Some examples of surfaces which can be protected include, but are not limited to metal; wood; polymer; fabric, including woven and nonwoven fabrics; leather, ceramic, glass, drywall & ceiling tile material, composite, masonry, stone; and other surfaces.

A still further aspect of the present disclosure involves a surface including a surface treatment capable of killing and preventing the proliferation of a range of microorganisms that cause disease and/or infection. Such surface treatments include one or more heat labile biocides adsorbed onto one or more carrier particle enabling the one or more biocides to maintain their activity against a broad range of microorganisms even after experiencing periods at an elevated temperature. Other heat labile component/carrier combinations can similarly be included in the surface treatments.

### DETAILED DESCRIPTION

For the purposes of promoting an understanding of what is claimed, references will now be made to the embodiments illustrated and specific language will be used to describe the same. It will nevertheless be understood that no limitation of scope of what is claimed is thereby intended, such alterations and further modifications and such further applications of the principles thereof as illustrated therein being contemplated as would normally occur to one skilled in the art to which the disclosure relates.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often though may not occur, and that the description includes instances where said event or circumstance occurs and instances where it does not.

Broadly considered, the method disclosed herein, generally involves subjecting a formulation containing heat labile component/carrier combination to a processing step carried out at processing temperatures above the component's decomposition, volatilization, and/or inactivation temperature without the component's decomposition, evaporation, and/or inactivation. Examples of suitable formulation include, but are not limited to paints, coatings, stains, varnishes, sealants, films, inks, and the like, individually and collectively referred to herein as “surface treatments” which experience exposure to an elevated temperature related to the treatment's application or derived from the treated surface's environment. Decomposition, evaporation, or inactivation is avoided by first adsorbing the heat labile component onto a carrier prior to exposure to an elevated temperature, by minimizing the magnitude of elevated temperature or by limiting the exposure time. An elevated temperature is a temperature at or above a heat labile component's decomposition or volatilization temperature. Suitable carriers are stable to the processing conditions, have the ability to load sufficient heat labile component, and can have a generally low thermal conductivity. The method generally provides for combinations including one or more heat labile components that could not otherwise be processed without transformation including decomposition. Because some combinations of heat labile components become intractable upon mixing, interfering with the loading process, loading a single component into a single carrier offers a way to avoid such incompatibilities. This has provided superior results, particularly where multiple heat labile components are incompatible. The use of multiple components in multiple carriers has proven advantageous in creating combinations of components in a surface treatment, even when none of the components were heat labile, but otherwise formed intractable combinations when mixed without first being loaded into a carrier.

Heat labile components can additionally involve materials that are volatile at a surface treatment's processing temperature and unless incorporated into a carrier would vaporize, providing a surface without the volatile component. Incorporation of the volatile component into a carrier prior to incorporation of the volatile component/carrier combination into the surface treatment has prevented substantial volatilization during processing of surface treatments containing volatile components. Volatile fragrances loaded into a carrier can be successfully incorporated into a range of surface treatments to provide treated surfaces capable of slowly emitting the fragrance over a long period of time. Additionally, volatile materials such as animal and insect repellants can be successfully loaded into surface treatments rendering them capable of repelling animals or insects for long periods of time.

Coil coating provides one example in which elevated temperatures are used to cure a coating or evaporate a solvent. Coil coating is a linear process for applying a protective or decorative organic coating to flat metal sheets or strips. Although methods have been developed for applying water-based, solvent-based, and powder coatings, water and solvent-based coatings are more commonly applied. Typically, a metal strip is passed through a coating application station where rollers coat one or both sides of the strip. The strip passes through an oven where the coatings are dried and cured. Upon leaving the oven the strip is cooled, often with water, and dried. For some applications, a primer is applied before a final topcoat is applied. The coil coating process is an efficient method for coating large amounts of metal surface quickly, but exposes the uncured coating to temperatures as high as 300-500° C. Such elevated temperatures can cause rapid decomposition or volatilization of heat labile components. The use of heat labile component/carrier combinations allows for incorporation of the heat labile component into the coating without decomposition or volatilization.

In addition, certain paints, stains, varnishes, sealants, films, inks containing viruscides, with or without additional biocides can be prepared and applied without the use of the carrier technology, for surface treatments not requiring an elevated temperature and/or for surface treatments not experiencing elevated temperatures during the surface treatment's service. One example of such a surface coating is a standard latex paint used for an interior application. Depending on the nature of the viruscide, cationic or nonionic latexes are sometimes selected.

In the discussion which follows, specific compositions and methods will be described with regard to one or more heat labile components. It is understood that other heat labile components discussed herein and not mentioned herein can be utilized similarly to provide a variety of surface treatments and treated surfaces which contain the other heat labile components distributed across the surface. Surface treatments can be applied by brushing, spraying, spreading, powder coating, rolling, dipping, and the like. A variety of printing methods, including ink jet printing and offset printing can also be utilized.

A first aspect of the present disclosure involves a method for the incorporation of a heat labile component, such as a biocide, into a heat curable surface treatment such as, for example, a polyurethane or epoxy paint followed by a curing step wherein the uncured treated surface is exposed to an elevated temperature to effect curing of the surface treatment, without substantially decomposing the biocide. Prior to incorporation, the biocide is adsorbed onto a carrier. As noted above, suitable carriers are porous materials capable of remaining solid at any necessary processing temperatures and adsorbing a sufficient amount of a biocide. The curing step is carried out in a manner that minimizes the time the biocide/carrier combination is subjected to temperatures greater than the biocide's decomposition temperature, but for a time sufficient to allow the surface treatment to cure. The processing temperature is typically determined by the surface treatments properties and the nature of the processing step. Once a processing temperature has been determined, combinations of polymer/carrier/biocide can be provided and maintained at that temperature for varying amounts of time to determine a maximum processing time.

Surface treatments can involve paints, coatings, stains, varnishes, dyes, sealants, films, inks, and the like. The terms utilized here are not meant to be restrictive, but are only used to illustrate the nature of the present disclosure. The terms frequently have overlapping meanings For example, paint or stain can additionally be formulated to function as a sealant. A varnish can include a colorant, and provide both a colorant, and a film. With that understanding, examples of each of these surface treatments will be considered.

### Paints and Coatings:

Paints are typically applied to a surface to alter a surface's appearance, whereas a coating is typically a covering applied to a surface to alter the surface's properties such as for example, the surface's appearance, water permeability, corrosion resistance, wear or scratch resistance, and the like. Today's paints typically also serve to both alter a surfaces appearance and as a coating and are generally water-based (latex), oil-based, or powder coatings. Latex and oil-based paints are generally applied at ambient temperatures (in the order of 7° C. to 35° C., but after film formation can remain stable to temperatures as high as about 80° C. or higher, temperatures sometimes achieved in periods of direct sunlight. Latex paints can be anionic, cationic, or non-ionic. Some oil-based paints and powder coatings undergo a heat curing process that results in a surface having a finished surface coating. Paints which undergo a curing step at elevated temperatures typically fall into two classes: thermoset and thermoplastics. Thermoplastics are generally applied as a powder, and heated above the polymer's glass transition temperature to form a melt, which upon solidification forms a coating. Powdered thermoset coatings, typically melt in a similar manner, but also further polymerize to form a tough coating upon cooling. The heat labile component/carrier combination can be included in latex and/or oil base paints in the same manner as other solids such as pigments and the like are added. Alternatively, the heat labile component/carrier combination may be added to paint prior to application by the end user or by a of different heat labile component/carrier combinations can be added to provide combinations that would not be possible without employing a carrier system, because of the interaction of many heat labile components. The ability to load a paint with several otherwise incompatible components provides a benefit even to paint components that are not heat labile.

A powder coating is a coating that is applied as a free-flowing, dry powder. Unlike most other paints and coatings, a powder coating does not require a solvent to keep the binder and filler parts in a liquid suspension form. The powder is typically applied electrostatically and is then cured under heat to allow it to flow and form a “skin”. There are two main categories of powder coatings: thermosets and thermoplastics. The thermosets incorporate a cross-linking agent into the formulation. When the powder is baked, the cross-linking agent reacts with other chemical groups in the powder to polymerize, improving the performance properties. The thermoplastic coating does not typically undergo any additional reactions during the baking process, but only melts and flows over the surface to form the final coating. Powder coating are primarily used for coating metals, such as aluminium extrusions used for appliance cabinets, and automobile and bicycle parts. Some powder coating technologies can be used to coat other materials, such as MDF (medium-density fibreboard). The most common polymers used in powder coatings are polyester, polyurethane, polyester-epoxy (known as hybrid), straight epoxy (fusion bonded epoxy) and acrylics. Powder coatings material can be manufactured by mixing polymer granules with hardener, pigments and other powder ingredients in an extruder, heating the mixture and extruding the melted mixture to provide a flat, cooled ribbon that is broken into small chips. The chips are milled and sieved to provide a fine powder. A heat labile component/carrier combination can be added either prior to extrusion or following extrusion before milling or after milling and sieving, if the carrier particles are properly sized. The powder coating process typically involves at least three steps: 1) preparation or pre-treatment of the surface, (2) application of the powder, and (3) curing.

Liquid formulations of paints and coatings can also be applied and then cured at an elevated temperature. Curing involves driving off remaining solvent and in certain instances, additional polymerization/cross-linking For latex and oil-base coatings, a heat labile component/carrier combination can be added at any stage of the formulation, even just prior to application, with proper mixing. Particle size of the carrier particles should be in the same range of any other solid components, such as for example pigments and the like. Paints and coatings containing selected heat labile component/carrier combinations can, after exposure to an elevated temperature, exhibit properties derived from a heat labile component that includes bacteriocides, fungicides, algaecides, viruscides, insecticides, antibiotics, enzymes, repellents (animal and insect), herbicides, pheromones, molluscicides, acaricides, miticides, rodenticides, fragrances, and combinations thereof. Exposure to an elevated temperature can occur during application or during service of the surface treatment.

Further paints and coatings suitable for inclusion of biocides, including biocide/carrier combinations include, but are not limited to polyurethane dispersions (PUD's), silicone, silane, and siloxane dispersions, silicone modified polyurethanes, and combinations thereof, and silicone resins. These paints and coatings can be formulated as clear coats or with pigments, and be applied by brush, roller, spray, and other known application methods. The clear coats can be applied over existing surfaces in good repair. Other surface treatments may require some surface preparation, repair, and/or priming before application.

### Stains & Varnishes:

Stains are typically penetrating formulations utilized to alter the color of a surface, whereas varnishes both impart a color and provide a coating. Both stains and varnishes can be formulated to cure at elevated temperatures forming further cross-linking and altering the durability of the surface. More commonly stains and varnishes are cured at ambient temperatures, but frequently during the surface's service, are exposed to elevated temperatures. Incorporation of a heat labile component in a carrier helps avoid decomposition and/or volatilization of any heat labile component incorporated in the stain or varnish. Like paints and coatings, the heat labile component/carrier combination can be added to the formulation at the same stage that other solids are added, such as pigments and the like. Stains and varnishes containing selected heat labile component/carrier combinations can, after exposure to an elevated temperature, exhibit properties derived from a heat labile component that includes bacteriocides, fungicides, algaecides, viruscides, insecticides, antibiotics, enzymes, repellents (animal and insect), herbicides, pheromones, molluscicides, acaricides, miticides, rodenticides, fragrances, and combinations thereof. The clear coats described above under paints and coatings, may be considered as varnishes in some applications.

### Sealants:

Sealants can be colored or clear and are typically utilized to make a surface impervious to a liquid such as, for example, water. Sealants are frequently applied to masonry, wood, and other porous surfaces. The incorporation of a heat labile component/carrier combination into a sealant can be carried out in the same manner as described above for a paint or coating. Masonry surfaces provide more challenges regarding techniques that can be used to heat the surface and surface treatment. Infrared lamps and convection heaters, and combinations thereof have typically been used. Like paints and coatings, sealants can be latex, oil-based, and, depending on the surface, powder. The same techniques used to formulate paints and coatings can typically be utilized to formulate sealants. Sealants containing selected heat labile component/carrier combinations can, after exposure to an elevated temperature, exhibit properties derived from a heat labile component that includes bacteriocides, fungicides, algaecides, viruscides, insecticides, antibiotics, enzymes, repellents (animal and insect), herbicides, pheromones, molluscicides, acaricides, miticides, rodenticides, fragrances, and combinations thereof.

### Films:

Films can be prepared with a variety methods including the application of a solution or slurry, the curing of a powder coating, extrusion and the like. The resulting film is a thin membrane, skin, covering, or coating. Methods for applying a solution or slurry to form a film are similar to those used to apply paint or a coating. Solutions utilized for form films can be prepared by dissolving a polymer in an appropriate solvent that can evaporate upon application to leave a polymer film. Latexes can be similarly prepared and transformed into a film. Finally, polymer films can also be prepared from powders, in the same manner as powder coatings. Spin coating has developed as a method for applying a variety of films on to a silica wafer and the like. For some applications, a single film layer can be applied. For other applications, multiple layers of the same or a different film material can be applied. Films can be prepared from a wide range of materials including organic and inorganic polymers, ceramics, and the like.

Films, including a heat labile component which will experience an elevated temperature during formation or during later service, can benefit from the utilization of a heat labile component/carrier combination to protect the heat labile component at the elevated temperatures. In addition, the use of components loaded onto different carriers can enable films to be prepared from otherwise incompatible components, thus providing novel properties.

### Inks:

Inks are typically applied to surfaces to impart an image and/or information. Although many inks cure at ambient temperature and conditions, other kinds of ink, such as those used in high speed printing presses such as lithograph or offset presses and other applications are heat cured to set the ink. In printing, it's often necessary to set the ink to avoid smearing as the printed web is cut and folded to form signatures. A variety of approaches have been utilized to cure/dry printing inks The printed paper web in a lithograph or offset press typically passes between gas burners at a fast rate to rapidly dry the ink at relatively high temperatures (but below the paper's ignition temperature) within a few seconds Ink jet technology has advanced and provides, yet another method for applying ink to a surface. Some inks designed for nonporous surfaces are also formulated to be stable to high temperatures, curing in the range of about 150 to about 300° C. and remaining stable to temperatures ranging from about 300 to about 800° C. The ability to modify such an ink with a heat labile component requires the heat labile component to be formulated in a manner to withstand the heating and curing conditions. Formulating such an ink with a heat labile component/carrier combination provides this necessary increased thermal stability.

One type of heat cured ink utilized for garments includes Plastisol inks, a family of inks composed primarily of two ingredients, PVC resin (a white powder) and plasticizer (a thick, clear liquid). The Plastisol inks must be heated cured in the range of 143-166° C. to properly bond to a fabric Inks containing selected heat labile component/carrier combinations can, after exposure to an elevated temperature, exhibit properties derived from a heat labile component that includes bacteriocides, fungicides, algaecides, viruscides, insecticides, antibiotics, enzymes, repellents (animal and insect), herbicides, pheromones, molluscicides, acaricides, miticides, rodenticides, fragrances, and combinations thereof.

Heat Labile Biocides:

Biocides utilized according to the present disclosure are generally biocides which have reduced stability when exposed to required processing conditions at temperatures above their decomposition temperature, or which are incompatible with one or more other components of the formulation. A majority are biocides which have limited heat stability that prevent their incorporation into polymers by standard methods.

Biocides generally suitable for processing according to the current disclosure include, but are not limited to: Acetylcarnitine, Acetylcholine, Aclidinium bromide, Acriflavinium chloride, Agelasine, Aliquat 336, Ambenonium chloride, Ambutonium bromide, Aminosteroid, Anilinium chloride, Atracurium besilate, Benzalkonium chloride, Benzethonium chloride, Benzilone, Benzododecinium bromide, Benzoxonium chloride, Benzyltrimethylammonium fluoride,

Benzyltrimethylammonium hydroxide, Bephenium hydroxynaphthoate, Berberine, Betaine, Bethanechol, Bevonium, Bibenzonium bromide, Bretylium, Bretylium for the treatment of ventricular fibrillation, Burgess reagent, Butylscopolamine, Butyrylcholine, Candocuronium iodide, Carbachol, Carbethopendecinium bromide, Carnitine, Cefluprenam, Cetrimonium, Cetrimonium bromide, Cetrimonium chloride, Cetylpyridinium chloride, Chelerythrine, Chlorisondamine, Choline, Choline chloride, Cimetropium bromide, Cisatracurium besilate, Citicoline, Clidinium bromide, Clofilium, Cocamidopropyl betaine, Cocamidopropyl hydroxysultaine, Complanine, Cyanine, Decamethonium, 3-Dehydrocarnitine, Demecarium bromide, Denatonium, Dequalinium, Didecyldimethylammonium chloride, Dimethyldioctadecylammonium chloride, Dimethylphenylpiperazinium, Dimethyltubocurarinium chloride, DiOC6, Diphemanil metilsulfate, Diphthamide, Diquat, Distigmine, Domiphen bromide, Doxacurium chloride, Echothiophate, Edelfosine, Edrophonium, Emepronium bromide, Ethidium bromide, Euflavine, Fenpiverinium, Fentonium, Gallamine triethiodide, Gantacurium chloride, Glycine betaine aldehyde, Glycopyrrolate, Guar hydroxypropyltrimonium chloride, Hemicholinium-3, Hexafluronium bromide, Hexamethonium, Hexocyclium, Homatropine, Hydroxyethylpromethazine, Ipratropium bromide, Isometamidium chloride, Isopropamide, Jatrorrhizine, Laudexium metilsulfate, Lucigenin, Mepenzolate, Methacholine, Methantheline, Methiodide, Methscopolamine, Methylatropine, Methylscopolamine, Metocurine, Miltefosine, MPP+, Muscarine, Neurine, Obidoxime, Otilonium bromide, Oxapium iodide, Oxyphenonium bromide, Palmatine, Pancuronium bromide, Pararosaniline, Pentamine, Penthienate, Pentolinium, Perifosine, Phellodendrine, Phosphocholine, Pinaverium, Pipecuronium bromide, Pipenzolate, Poldine, Polyquaternium, Pralidoxime, Prifinium bromide, Propantheline bromide, Prospidium chloride, Pyridostigmine, Pyrvinium, Quaternium-15, Quinapyramine, Rapacuronium, Rhodamine B, Rocuronium bromide, Safranin, Sanguinarine, Stearalkonium chloride, Succinylmonocholine, Suxamethonium chloride, Tetra-n-butylammonium bromide, Tetra-n-butylammonium fluoride, Tetrabutylammonium hydroxide, Tetrabutylammonium tribromide, Tetraethylammonium, Tetraethylammonium bromide, Tetramethylammonium chloride, Tetramethylammonium hydroxide, Tetramethylammonium pentafluoroxenate, Tetraoctylammonium bromide, Tetrapropylammonium perruthenate, Thiazinamium metilsulfate, Thioflavin, Thonzonium bromide, Tibezonium iodide, Tiemonium iodide, Timepidium bromide, Trazium, Tridihexethyl, Triethylcholine, Trigonelline, Trimethyl ammonium compounds, Trimethylglycine, Trolamine salicylate, Trospium chloride, Tubocurarine chloride, Vecuronium bromide.

One group of heat labile biocides includes, but is not limited to, quaternary amines and antibiotics. Some specific preferred heat labile biocides include, but are not limited to, N,N-didecyl-N-methyl-N-(3-trimethoxysilylpropyl)ammonium chloride, cetyl pyridinium chloride, N,N-bis(3-aminopropyl)dodecylamine, N-octyl-N-decyl-N-dimethyl-ammonium chloride, N-di-octadecyl-N-dimethyl-ammonium chloride, and N-didecyl-N-dimethyl-ammonium chloride.

Some specific antibiotics include, but are not limited to amoxicillin, campicillin, piperacillin, carbenicillin indanyl, methacillin cephalosporin cefaclor, streptomycin, tetracycline and the like. Preferred combinations of biocides generally include at least one heat labile biocide, which would not survive incorporation into a specific polymer unless adsorbed onto a carrier. Examples of preferred fungicides include iodopropynylbutylcarbamate; N-[(trichloromethyl)thio]phthalimide; and chlorothalonil. Examples of preferred bactericides include benzisothiazolinone and 5-chloro-2-methyl-4-isothiazolin-3-one. Other biocides which can be utilized according to this disclosure include, but are not limited to, bactericides, fungicides, algicides, miticides, viruscides, insecticides, herbicides rodenticides, animal and insect repellants, and the like. Fragrances and other volatile heat labile components can similarly be incorporated into the various polymers at elevated temperatures.

The Carriers:

Suitable carriers are typically porous materials capable of adsorbing the heat labile biocide, remaining in a solid form during processing, and maintaining the biocide in the adsorbed state during processing. Although carriers studied thus far have had a substantial porosity and a high surface area (mostly internal), any level of surface area can be utilized. The amount of surface area primarily affects the amount of carrier needed to provide a specific desired effect. An additional property suitable for a carrier is a relatively low thermal conductivity. Finally, carriers can be selected to alter the color and/or appearance of a treated surface, if desired, or provide a surface unaltered by the carrier's presence.

Inorganic Carriers: As a class, platy minerals generally perform well as carrier materials. Minerals suitable for use as carriers include, but are not limited to fumed and other forms of silicon including precipitated silicon and vapor deposited silicon; clay; kaolin; perlite bentonite; talc; mica; calcium carbonate; titanium dioxide; zinc oxide; iron oxide; silicon dioxide; and the like. At this time, substantial testing has been carried out with silica (silicon dioxide) as the carrier. Mixtures of carriers can also be utilized.

Organic Carriers: A further class of carriers that has proven suitable includes polymeric carriers. Preferred polymeric carriers remain solid at elevated temperatures and are capable of loading sufficient quantities of heat labile component. One example of polymeric carriers includes cross-linked macroreticular and gel resins, and combinations thereof such as the so-called plum pudding polymers. An example of a plum pudding resin includes a crosslinked macroreticular polymeric carrier containing particles of other resins within their structure. Suitable resins for imbedding within a macroreticular resin include other macroreticular resins or gel resins. Additionally, other porous or non-porous non-polymeric materials such as minerals can similarly be incorporated within the macroreticular resin.

Organic polymeric carriers can include polymers lacking a functional group, such as a polystyrene resin, or the organic polymeric carrier can have a functional group such as a sulfonic acid included. Generally, any added functional group should not substantially reduce the organic polymeric carrier's thermal stability. A suitable organic polymeric carrier should also be able to load a sufficient amount of a heat labile component, and survive any processing conditions, and deliver an effective amount of the heat labile component to the upper regions of the surface treatment upon incorporation into any surface treatment system. Suitable organic polymeric carriers can be derived from a single monomer or a combination of monomers.

General methods for making macroreticular and gel polymers or resins are well known in the art utilizing a variety of monomers and monomer combinations. Suitable monomers for the preparation of organic polymeric carriers include, but are not limited to styrene, vinyl pyridines, ethylvinylbenzenes, vinyltoluenes, vinyl imidazoles, an ethylenically unsaturated monomers, such as, for example, acrylic ester monomers including methyl acrylate, ethyl acrylate, butyl acrylate, 2-ethylhexyl acrylate, decyl acrylate, methyl methacrylate, butyl methacrylate, lauryl(meth)acrylate, isobornyl(meth)acrylate, isodecyl(meth)acrylate, oleyl(meth)acrylate, palmityl(meth)acrylate, stearyl(meth)acrylate, hydroxyethyl(meth)acrylate, and hydroxypropyl(meth)acrylate; acrylamide or substituted acryl amides; styrene or substituted styrenes; butadiene; ethylene; vinyl acetate or other vinyl esters such as vinyl acetate, vinyl propionate, vinyl butyrate and vinyl laurate; vinyl ketones, including vinyl methyl ketone, vinyl ethyl ketone, vinyl isopropyl ketone, and methyl isopropenyl ketone; vinyl ethers, including vinyl methyl ether, vinyl ethyl ether, vinyl propyl ether, and vinyl isobutyl ether; vinyl monomers, such as, for example, vinyl chloride, vinylidene chloride, N-vinyl pyrrolidone; amino monomers, such as, for example, N,N′-dimethylamino(meth)acrylate; and acrylonitrile or methacrylonitrile; and the monomethacrylates of dialkylene glycols and polyalkylene glycols. Descriptions for making porous and macroreticular polymers can be found in U.S. Pat. No. 7,422,879 (Gebhard et al.) and U.S. Pat. No. 7,098,252 (Jiang et al.).

The organic polymeric carriers can contain other organic polymeric particles and/or other inorganic carrier particles, such as minerals typically characterized as platy materials. Minerals suitable for incorporation into a polymeric carrier include, but are not limited to fumed and other forms of silicon including precipitated silicon and vapor deposited silicon; clay; kaolin; perlite bentonite; talc; mica; calcium carbonate; titanium dioxide; zinc oxide; iron oxide; silicon dioxide; and the like. Mixtures of different carriers can also be utilized.

Selection of Components:

The choice of a specific surface treatment is generally made to provide a treated surface exhibiting one or more new and desired properties and a cost consistent with its application. Carriers are typically selected based on their porosity, surface area, thermal conductivity, and the impact on the surface's appearance. Carriers having a low thermal conductivity can be utilized, but are not required. Porosity and surface area determine how much heat labile component can be loaded onto the carrier and generally reduces the amount of carrier required. The thermal conductivity is believed to contribute to how much above a heat labile component's decomposition temperature the polymer can be processed and how long the processing step can take. For example, a carrier having a high thermal conductivity may be advantageous in processing a polymer/heat labile component combination where the surface treatment's processing temperature is only slightly above the biocide's decomposition temperature and/or the processing time is relatively short. For processing temperatures well above the heat labile component's decomposition temperature or for processing for longer times, a carrier having a lower thermal conductivity may be advantageous. The selection of heat labile component primarily depends on the use of the polymer/heat labile component combination. For example, if the heat labile component is a biocide, the biocide loading can be tailored to target specific microorganisms or specific combinations of microorganisms, depending on the end use. Combinations of biocides can be utilized including both heat stabile and heat labile biocides in order to fulfill specific needs. In addition, combinations of biocides including bactericides, viruscides, fungicides, insecticides, herbicides, miticides, rodenticides, animal and insect repellants, and the like can be incorporated into a single polymer, depending on it end use and the properties the treated surface is intended to exhibit.

The utilization of carriers in formulating surface coatings can prove useful even when one or more of the components loaded onto one or more carriers is not a heat labile component. For example, the addition of multiple components into a surface treatment can result in incompatibilities between the various components and between the components and the surface treatment formulation. By adding the various components to the surface treatment formulation in the form of individual component/carrier combinations, the incompatibilities that would otherwise result are generally avoided.

The Process:

The carrier/heat labile component combination has been produced by contacting a carrier with a liquid form of the heat labile component (typically a solution or a suspension), allowing adsorption onto the carrier to occur and evaporating any solvent to provide the carrier/heat labile component combination in the form of a flow-able powder. Heat labile component/carrier particles containing as much as 60% (by weight) heat labile component have been prepared.

A processing temperature can be established for a surface treatment/heat labile component combination and a maximum processing time at the processing temperature can be established, before the processing is carried out. It's generally advantageous to utilize conventional application and processing equipment in a manner to minimize the processing time for the surface treatment/heat labile component combination. Generally, powder coatings and liquid formulations containing a heat labile component/carrier combination can be applied and cured in any suitable manner. The elevated temperatures necessary for a curing step can be provided by infrared heaters, resistance heaters, ovens, solar heaters, sunlight, radiant heaters, gas burners, microwave, and the like. Surface treatments not requiring a heat curing step as part of the application can be applied and cured by standard methods and later have the ability to withstand elevated temperatures in the course of their service. Carrier/heat labile component loading into a surface treatment can run as high as about 40 wt. % carrier/heat labile component. For finished surface treatments where the heat labile component is a biocide, biocide levels within the surface ranging from about 0.25 wt. % to 10 wt. % have proven effective against microorganism's tested. However, both higher and lower loadings are contemplated and will be effective. The desired loading of a heat labile component/carrier will vary substantially depending on the type of heat labile component utilized and the property intended to be exhibited by the treated surface.

Applications Utilizing Biocidal Polymers to illustrate Utility:

Applications involving the surface treatment/biocide combination taught herein include, but are not limited to a wide range of surfaces and equipment utilized in the medical and consumer fields including hospital, emergency treatment, first aid, and the like. The surface treatments of this present disclosure can be applied to a variety of surfaces found on/in structures, articles, containers, devices, woven/nonwoven articles, remediation materials, and the like as well as their components. Any product that is or could be constructed and coated with a surface treatment including a biocide/carrier combination, that otherwise requires processing at an elevated temperature, and which would benefit from the ability to limit the growth of microorganisms can be improved by utilizing the polymer/biocide combinations taught herein. Some specific examples of structures that benefit from the application of surface treatments include, but are not limited to buildings, airliners, buses, trains, cruise ships, buses, and the like. Some specific surfaces include, but are not limited to things we touch such as: walls, counter tops, furniture components (e.g. a bed rail, a toilet seat, a shower stall, a sink, etc.), and equipment (e.g. a bed pan, a door handle, appliances, shopping cart handles, a writing instrument, a computer keyboard, a telephone, dental equipment, etc.) and surgical equipment. In addition, air filters having components surface treated with a coating containing a biocide/carrier combination can minimize the microorganism content of the air circulating within a hospital, an office building, a hotel, a home, or other structure with central air handling equipment. Finally, treated surfaces can provide additional protection against a range of biological hazards or weapons. Many of the articles above are also important components in schools, where colds, influenza, and the like typically spread quickly through surface contacts and air-born microorganisms. Surface treatments containing insecticides can be utilized to treat articles such as siding, molding such as baseboards, flooring, and the like to allow the killing of susceptible insects that contact the surface treatment/insecticide material.

Finally, the present disclosure provides for surface treatment formulations utilizing the carrier technology which can contain heat labile components that can be selected from the group consisting of bactericides, fungicides, insecticides, rodenticides, volatile fragrances (including animal and insect repellants), and the like. Such surface treatment materials are particularly suitable for treating a variety of building materials, and for manufacturing garbage cans, recycling bins and other equipment designed to handle garbage, food wastes, and the like. Articles treated with this surface treatment formulation can mask odors, minimize bacterial and fungal growth, retard the proliferation of flies and other harmful insects, and prevent the proliferation of rodents. The incorporation of animal repellants in surface treatment materials utilized for garbage handling equipment/articles handling and exposed to food products can also keep pets and wild animals away. This is particularly desirable for garbage cans/equipment awaiting pickup in unattended locations. Surface treatments can be selected to provide the appropriate level of protection and safety to for each application, and to avoid the leaching substantial amounts of heat labile component into the environment.

Preparation of the Carrier Package:

250 grams of SiO2, 200 grams, 200 grams of an solution of N Bis(3-aminopropyl)dodecylamine chloride (as a 60% N,N Bis(3-aminopropyl)dodecylamine chloride) and 40 grams of fumed silica (SiO₂) were combined and mixed in a high speed mixer (about 1200 rpm) for about 2 minutes at ambient temperature to provide a flow-able powder. Sufficient amounts of additional dilute solutions of the N-Bis(3-aminopropyl)dodecylamine chloride were added to convert the flow-able powder into a wet paste. The following components were added to the wet paste: 20 grams TiO2, 20 grams of Ion pure (silver iodide coated onto 5-10 micron glass beads), 30 grams of DIISOBULYLPHENOXYETHOXY ETHYL DIMETHYL BENZYL AMMONIUM CHLORIDE MONOHYDRATE, and 200 grams of aqueous N,N Bis(3-aminopropyl)dodecylamine chloride. The combination was compounded for about 2 minutes at ambient temperature at a low mix rate less than 1200 rpm to mix the moist paste and the resulting paste was compressed in a high speed shaker to remove any entrained air.

Additional components, 4.2 grams of N-ALKYL (C14-50%, C12-40%, C16-10%), 0.5 grams of SiO₂ and 0.5 grams of TiO₂ were incorporated into the thick paste as described above. Sufficient N,N-Bis(3-aminopropyl)dodecylamine chloride was added to maintain the material in the form of a thick paste that was thoroughly mixed. This process was repeated sequentially with the addition of biocides 3-29.

The following biocides were all included into the carrier package sequentially as described above:
(1) N,N-Bis(3-aminopropyl)dodecylamine chloride,
(2) N-ALKYL (C14-50%, C12-40%, C16-10%)
(3) DIMETHYL BENZYL AMMONIUM CHLORIDE,
(3) 1,3-BIS(HYDROXYMETHYL)-5,
(4) 5-DIMETHYLHYDANTOIN,1-(HYDROXYMETHYL)-5,5-DIMETHYLHYDANTOIN,
(6) 3-IODO-2-PROPYNYL BUTYL CARBAMATE,
(7) DIDECYL DIMETHYL AMMONIUM CHLORIDE,
(8) N-ALKYL (C14-50%, C12-40%, C16-10%) DIMETHYL BENZYL AMMONIUM CHLORIDE,
(9) 1,3-DI-(HYDROXYMETHYL)-5,5-DIMETHYLHYDANTOIN,
(10) 3-(HYDROXYMETHYL)-5,5-DIMETHYLHYDANTOIN, 5,5-DIMETHYLHYDANTOIN,
(11) 5-CHLORO-2-METHYL-4-ISOTHIAZOLIN-3-ONE,
(12) 2-METHYL-4-ISOTHIAZOLIN-3-ONE,
(13) N-ALKYL (C14-60%,C16.30%, C12-50%, C18-5%) DIMETHYL BENZYL AMMONIUM CHLORIDE,
(14) N-ALKYL (C12-50%, C14-30%, C16-17%, C18.3%) DIMETHYL BENZYL AMMONIUM CHLORIDE, DIOCTYL DIMETHYL AMMONIUM CHLORIDE, DIDECYL DIMETHYL AMMONIUM CHLORIDE,
(15) N,N-DIDECYL-N,N-DIMETHYLAMMONIUM CHLORIDE,
(16) ETHANE-1,2-DIOL, N,N BIS(3-AMINOPROPYL)DODECYLAMINE,
(17) DIMETHYL BENZYL AMMONIUM CHLORIDE,
(18) OCTYL DECYL DIMETHYL AMMONIUM CHLORIDE,
(19) DIOCTYL DIMETHYL AMMONIUM CHLORIDE,
(20) 1-BROMO-3-CHLORO-5,5-DIMETHYLHYDANTOIN,
(21) 3-BROMO-1-CHLORO-5,5-DIMETHYLHYDANTOIN,
(22) 1,3-DIBROMO-5,5-DIMETHYLHYDANTOIN,
(23) BORIC ACID
(24) N-TRICHLOROMETHYLTHIO-4-CYCLOHEXENE-1,2-DICARBOXIMIDE,
(25) N-(TRICHLOROMETHYLIO)PHTHAALIMIDE, CARBAMIC ACID
(26) BUTYL-,3-IODO-2-PROPYNYLESTER 55406-53-6,
(27) 3-IODO-2-PROPYNL BUTYL CARBAMATE,
(28) 3-IODO-2-PROPYNL BUTYL CARBAMATE,
(29) (TETRACHOROISOPHTHALONITRILE)
   The carrier package was milled to about 1 micron and dried to provide a free-flowing powder.

### Preparation of Masterbatch Biocide/Resin Combinations:

The carboxyl functional polyester resin was extruded at a temperature sufficient to form a melt with the addition of 10% by weight of the biocide carrier package. The extruded material was cooled to form a solid, the solid was broken into chunks, ground and ultimately milled. An epoxy resin biocide combination was similarly prepared to form a biocide/epoxy combination. Masterbatch materials containing 15-20 wt. % can also be prepared to increase the biocidal activity.

### Preparation of the Coating Package:

General Procedure—The coating materials including the carrier package were combined and mixed through a high intensity mixer for about 3 minutes. The resulting premix material was extruded at about 80-85° C. and the resulting extruded material chilled to form a solid sheet. The solid sheet of material was broken into chips and ground to form a powder suitable for application as a powder coating.

### Preparation and Application of Latex and Oil Base Coatings:

The carrier package described above can be included in a latex or oil base coating with agitation to ensure complete mixing. The resulting latex or oil base coatings can be dried at elevated temperatures and utilized at elevated service temperatures without decomposition of the heat labile component adsorbed on the carrier.

### Preparation of Clear Polyester Coating:

950 g of Polyester Primid (a Carboxyl functional polyester resin); 38 g of a Primid (hydroxyalkylamide crosslinker); 10 g of rheoflow (a flow agent); and 100 g of biocide/resin masterbatch (10% biocide in Polyester Primid) were combined and processed according to the procedure described for the preparation of a coating package to provide a clear powder coat material. Primid is a registered trademark of EMS Chemie Ag Corporation, Via Innovativa 1 Domat/Ems SWITZERLAND. Increased amounts of the masterbatch material can be utilized to increase the biocidal activity.

### Preparation of Epoxy Powder Coating:

275 g of epoxy resin (Epotec YD901), 275 g of a carboxyl functional polyester resin 50/50 hybrid (benzene-1,3-dicarboxylic acid; dimethylbenzene-1,4-dicarboxylate;2,2-dimethylpropane-1,3-diol;ethane-1,2-diol), 34.5 g of ptef modified pe wax/BENZOINzhydroxy-1 z-di(phenyl)ethanone, 188 g if titanium, 22 g of titanium extender, 8 g of pigment (red, yellow, and black), 100 g of barium sulfate, 100 g calcium carbonate, and 100 g of biocide epoxy resin combination (10 biocide in epoxy resin) were combined and processed according to the procedure described for the preparation of a coating package to provide a clear powder coat material. Increased amounts of the masterbatch material can be utilized to increase the biocidal activity.

### Application of Powder Coat Materials:

Coatings based on the polyester clear coat and the epoxy powder coatings were applied to a surface for testing. Sheets of cold rolled steel (3 inches by 5 inches) were powder coated with an electrostatic spray gun according to standard procedures and the coated sheets cured at about 190° C. (or about 375° F.) for about 15 minutes. Test samples were cut to provide test materials approximately 50 mm by about 90 mm (2 inches by 3½ inches). The test samples were utilized in the test described in the following description.

### Testing of Coated Samples:

(a) Testing Protocol:

### Calculation of Titers

Viral and cytotoxicity titers will be expressed as −log₁₀ of the 50 percent titration endpoint for infectivity (TCID₅₀) or cytotoxicity (TCD₅₀), respectively, as calculated by the method of Spearman Karber.

$$- Log of 1 st dilution inoculated - [ \begin{matrix}( ( \frac{Sum of \% mortality at each dilution}{100} ) - 0.5 ) \times \\ ( logarithm of dilution )\end{matrix} ] \\ Geometric Mean = Antilog of \text{:} \frac{{Log}_{10} {X}_{1} + {Log}_{10} {X}_{2} + {Log}_{10} {X}_{3} + {Log}_{10} {X}_{4}}{{4}^{*}} \\ ( \frac{X equals {TCID}_{50}}{volume inoculated for each test or control replicate} ) \\ {}^{*} This value ( or number of values for X ) may be adjusted depending on the number of replicates carried out .$$

### Calculation of Log Reduction

Virus Control TCID₅₀−Test Substance TCID₅₀=Log Reduction

### Calculation of Percent Reduction

Calculation of Percent Reduction

$$\% Reduction = 1 - [ \frac{{TCID}_{50} test}{{TCID}_{50} virus control} ] \times 100$$

(b) Testing: Feline Calicivirus 1 (ATCC VR-782)

The F-9 strain of Feline Calicivirus obtained from the American Type Culture Collection, Manassas, Va. (ATCC VR-782) was utilized in testing. Stock virus was prepared by collecting supernatant fluid from 70-100% infected culture cells. The cells were disrupted, centrifuged and the supernatant fluid removed, aliquoted, and the titer stock virus stored at ≦−70° C. Cultures of Crandel Reese feline kidney (CRFK) cells obtained from the American Type Culture Collection, Manassas, Va. (ATCC CCL-94) were utilized as indicator cells. The test media utilized was Minimum Essential Medium (MEM) supplemented with 5% (v/v) heat-inactivated fetal bovine serum (FBS). Tests were carried out on pre-coated and pre-cut sections of material (approximately 50 mm×90 mm or 2 inches by 3½ inches) and controls of a similar size. Samples and control were dipped in ethanol and allowed to dry before testing. Just prior to testing, the stock virus was titered by a 10 fold serial dilution and assayed for infectivity in order to determine the starting titer of the virus.

Test samples and control samples contained in sterile petri dishes were inoculated with a 100 μL aliquots of the test virus. The inoculated test samples were covered with a film prepared from a sterile stomacher bag, and the film pressed down sufficiently to spread the virus over the film and maintained at room temperature (20° C.) for 5 minutes. Following the exposure time, a 1.00 mL aliquot of test medium was pipetted individually onto each test and control sample. The surfaces of each of the samples or control materials were individually scraped with a sterile plastic cell scraper, the test mediums individually collected, and the separate collected materials mixed with a vortex type mixer before undergoing 10 fold dilutions. A control measurement was carried out with a test sample by substituting 100 μL of test medium for the virus. After 1 hour in a controlled chamber at room temperature and at 50% relative humidity, the sample was processed in the same manner as the virus seeded samples.

The different samples were finally utilized in an infectivity assay involving the CRFK cell line. CRFK cells in multi-well culture dishes were inoculated with 100 μL of the dilutions prepared from the test and control samples. Uninfected indicator cell cultures (cell controls) are inoculated with test medium alone. Cultures were incubated at 31-35° C. in a humidified atmosphere of 5-7% CO₂. The cultures were microscopically scored periodically for seven days for the absence or presence of cytotopathic effect. The polyester powder coat samples tested demonstrated a 90.0% reduction in viral toxicity following a 5 minute exposure time (a log reduction of 1.00 log₁₀), whereas the epoxy powder coating samples demonstrated a 68.4% reduction following a 5 minute exposure (a log reduction of 0.5 log₁₀). The table below summarizes these results.

TABLE 1

5 Minute Exposure Time

| Reduction | Polyester Coating | Epoxy Coating |
|---|---|---|
| % Reduction | 90.0% | 68.4% |
| Log₁₀ Reduction | 1.00 Log₁₀ | 0.50 Log₁₀ |

Applicants' disclosure has been illustrated with examples of thermoset powder coatings. Other surface treatments include, but are not limited to, paints, coatings, stains, varnishes, sealants, films, inks, and the like (collectively, “surface treatments”). These surface treatments can be prepared utilizing the procedures provided herein to incorporate heat labile components and/or incompatible components therein that retain their physical properties in the resulting surface treatment. This procedure also allows for the formation of new combinations of otherwise incompatible components. Heat labile components can include, but are not limited to, a wide range of biocides, repellents, UV stabilizers, fragrances, and the like. Specific examples of heat labile biocides include, but are not limited to bacteriocides, fungicides, algaecides, viruscides, insecticides, antibiotics, enzymes, repellents (animal and insect), herbicides, pheromones, molluscicides, acaricides, miticides, rodenticides, fragrances, and the like. Other heat labile components with or without biocidal properties can also be incorporated into the coatings utilizing the procedures taught herein.

While applicant's disclosure has been provided with reference to specific embodiments above, it will be understood that modifications and alterations in the embodiments disclosed may be made by those practiced in the art without departing from the spirit and scope of the invention. All such modifications and alterations are intended to be covered.

1. A surface treatment including a heat labile component adsorbed on a carrier, wherein:
(a) the surface treatment has an exposure temperature;
(b) the heat labile component has a decomposition temperature;
(c) the surface treatment's exposure temperature is ≧ to the heat labile component's decomposition temperature; and
(d) the surface treatment is capable of experiencing the exposure temperature without decomposition of the heat labile component.

2. The surface treatment of claim 1, wherein the exposure temperature is a processing temperature experienced by the surface treatment during its application.

3. The surface treatment of claim 1, wherein the exposure temperature is a service temperature experienced by the surface treatment during its service following application.

4. The surface treatment of claim 1, wherein the surface treatment is selected from the group consisting of a thermoplastic coating, a thermoset coating, a latex coating, and an oil-base coating.

5. The surface treatment of claim 1, wherein the heat labile component is a heat labile biocide.

6. The surface treatment of claim 5, wherein the heat labile biocide is a quaternary amine derivative and the surface treatment's processing temperature is ≧80° C.

7. The surface treatment of claim 5, wherein the heat labile biocide selected from the group consisting of a bactericides, fungicides, insecticides, rodenticides, volatile fragrances (including animal and insect repellants), and combinations thereof.

8. The surface treatment of claim 1, wherein the surface treatment is selected from the group consisting of a paint, a coating, a stain, a varnish, a sealant, a film, and an ink.

9. The surface treatment of claim 1, wherein the heat labile component is heat labile because of its volatility.

10. The surface treatment of claim 1, wherein the heat labile component is a fragrance.

11. The surface treatment of claim 1, further including a plurality of heat labile components, at least two of which are incompatible.

12. A method for applying a surface treatment including a heat labile component/carrier combination comprising:
(a) applying a surface treatment including a heat labile component adsorbed on a carrier to a surface, wherein the surface treatment has an processing temperature, and the heat labile component has a decomposition temperature;
(b) subjecting the surface to the application temperature for a time sufficient to form a coated surface; and
(c) cooling the coated surface;
wherein, the processing temperature is greater than the heat labile component's decomposition temperature; and the heat labile component is distributed throughout the surface treatment.

13. The method of claim 12, wherein applying a surface treatment including a heat labile component adsorbed on a carrier to a surface, involves applying a surface treatment including a heat labile component that is a biocide.

14. The method of claim 13, wherein applying a surface treatment including a heat labile biocide adsorbed on a carrier to a surface, involves applying a surface treatment including a heat labile biocide that is a quaternary amine derivative and the surface treatment's processing temperature is ≧80° C.

15. The method of claim 13, wherein the heat labile biocide provided is selected from the group consisting of a bactericides, fungicides, insecticides, rodenticides, volatile fragrances (including animal and insect repellants), and combinations thereof.

16. The method of claim 12, wherein the surface treatment provided is a surface treatment selected from the group consisting of a paint, a coating, a stain, a varnish, a sealant, a film, and an ink.

17. The method of claim 12, wherein applying a surface treatment including a heat labile component adsorbed on a carrier involves applying a mixture containing a plurality of heat labile components, at least two of which are incompatible.

18. The method of claim 12, wherein applying a surface treatment including a heat labile component adsorbed on a carrier to a surface involves applying a powder coating formulation.

19. The method of claim 18, wherein applying a surface treatment including a heat labile component adsorbed on a carrier involves applying a surface treatment selected from the group consisting of a thermoset and a thermoplastic.

20. The method of claim 19, wherein applying a surface treatment including a heat labile component adsorbed on a carrier involves applying a thermoset surface treatment selected from the group consisting of a polyester coating and an epoxy coating.

21. The method of claim 12, wherein applying a surface treatment including a heat labile component adsorbed on a carrier involves applying a surface treatment selected from a paint, a coating, a stain, a varnish, a sealant, a film, and an ink.

22. A surface having a surface treatment thereon, wherein:
(a) the surface treatment has an exposure temperature and includes a heat labile component adsorbed on a carrier;
(b) the heat labile component has a decomposition temperature;
(c) the coating formulation's exposure temperature is ≧ to the heat labile component's decomposition temperature; and
(d) the surface treatment is capable of experiencing the exposure temperature without decomposition of the heat labile component.

23. The surface of claim 22, wherein the surface treatment has an exposure temperature which includes an processing temperature.

24. The surface of claim 22, wherein the surface treatment has an exposure temperature which includes a service temperature.

25. The surface of claim 22, wherein the surface treatment including a heat labile component adsorbed on a carrier includes a heat labile component selected from the group consisting of a bactericides, fungicides, insecticides, rodenticides, volatile fragrances (including animal and insect repellants), and combinations thereof.

26. A method for preparing a surface treatment comprising: (a) providing a surface treatment; (b) providing a heat labile component adsorbed on a carrier; and (c) combining the heat labile component adsorbed on a carrier and the surface treatment.

27. The method of claim 26, wherein the method of providing a surface treatment involves providing a surface treatment selected from the group consisting of paint, a coating, a stain, a varnish, a sealant, a film, and an ink.

28. The method of claim 27, wherein the method of providing a surface treatment involves providing a paint.

29. The method of claim 28, wherein the method of providing a paint involves providing a paint selected from the group consisting of a latex paint, an oil-base paint, a thermoset paint, and a thermoplastic paint.

30. The method of claim 26, wherein providing a heat labile component adsorbed on a carrier involves providing a heat labile biocide adsorbed on a carrier.

31. The method of claim 26, wherein providing the heat labile component adsorbed on a carrier involves providing a heat labile component selected from the group consisting of a bactericides, fungicides, insecticides, rodenticides, volatile fragrances (including animal and insect repellants), and combinations thereof.

32. A method for preparing a surface treatment comprising: (a) providing a surface treatment; (b) providing at least two incompatible components adsorbed on at least two carriers; and (c) combining the at least two incompatible components adsorbed on at least two carriers and the surface treatment.
